(19) United States
(12) Patent Application Publication
(10) Pub. No.: US 2016/0372288 A1
(43) Pub. Date: Dec. 22, 2016

(54) SWITCHGEAR

(71) Applicant: EATON INDUSTRIES (AUSTRIA) GMBH, Schrems (AT)

(72) Inventor: Rainer FAAST, Altnagelberg (AT)

(73) Assignee: EATON INDUSTRIES (AUSTRIA) GMBH, Schrems (AT)

(21) Appl. No.: 15/105,596

(22) PCT Filed: Dec. 18, 2014
(86) PCT No.: PCT/EP2014/078513

§ 371 Date: Sep. 7, 2016

(30) Foreign Application Priority Data
Dec. 18, 2013 (DE) 10 2013 114 400.4

(51) Int. Cl. H01H 71/02; H01H 9/02

(52) U.S. Cl. CPC H01H 71/0228; H01H 9/02; H01H 71/025

(57) ABSTRACT

A switchgear has a housing with a fastening device for mounting the switchgear on a supporting rail arranged on the housing. The fastening device has a stationary first fastening lug and a second fastening lug arranged opposite the first fastening lug. The second fastening lug can be stationary, a spring is arranged in the region of the second fastening lug and is preloaded in the direction of the first fastening lug, and the spring projects partly into a groove which is delimited by the second fastening lug.

### CROSS-REFERENCE TO RELATED APPLICATIONS

This application is a U.S. national stage application under 35 U.S.C. §371 of International Application No. PCT/EP2014/078513, filed on Dec. 18, 2014, and claims benefit to German Patent Application No. DE 10 2013 114 400.4, filed on Dec. 18, 2013. The International Application was published in German on Jun. 25, 2015, as WO 2015/091831 A1 under PCT Article 21(2).

### FIELD

The invention relates to a switchgear including a fastening device attached to a housing.

### BACKGROUND

It is known and very common practice to fasten switchgear, in particular “installation switchgear”, to DIN rails. DIN rails of this type are common in distribution cabinets. The switchgear accordingly provided comprises, on the rear thereof, a fastening lug fixed to the housing and a movably arranged latching slide.

Switchgear of this type is disadvantageous in that the movable latching slides are complex components that have to be mounted in the switchgear housing so as to be longitudinally displaceable. Latching slides of this type also require a complex housing and incur significant costs.

Moreover, during production, they can only be installed before the individual housing parts of the protective switch have been joined together. Retrofitting or subsequent removal is not possible without impairing the proper functioning of the switchgear in question. In some applications, switchgear that is designed to switch just one phase is coupled to multiphase switchgear. Since this is switchgear that has been completely assembled and checked, no subsequent modifications are possible, and so the movable latching slides, of which there are now a plurality, cannot be modified either. A switchgear assembly of this type comprises an unnecessarily high number of latching slides.

### SUMMARY

An aspect of the invention provides a switchgear, comprising: a fastening device configured to attach the switchgear to a DIN rail, the fastening device being arranged on a housing of the switchgear, wherein the fastening device includes a stationary first fastening lug and a stationary second fastening lug arranged opposite the first fastening lug, wherein a spring is arranged in the region of the second fastening lug in a manner preloaded towards the first fastening lug, and wherein some regions of the spring protrude into a groove defined by the second fastening lug.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is an axonometric view of a first preferred embodiment of a switchgear according to the invention;

FIG. 2 is a first view of a detail of the switchgear according to FIG. 1;

FIG. 3 is a second view of a detail of the switchgear according to FIG. 1;

FIG. 4 is an axonometric view of a second preferred embodiment of a switchgear according to the invention;

FIG. 5 shows a detail of the switchgear according to FIG. 4;

FIG. 6 is an axonometric view of a third preferred embodiment of a switchgear according to the invention;

FIG. 7 shows a detail of the switchgear according to FIG. 6;

FIG. 8 is a view of a detail of a housing shell of the switchgear according to FIG. 6 with a separate spring;

FIG. 9 is an axonometric view of a fourth preferred embodiment of a switchgear according to the invention;

FIG. 10 is a view of a detail of a housing shell of the switchgear according to FIG. 6 with a separate spring; and

FIG. 11 is a cross section through a DIN rail.

### DETAILED DESCRIPTION

Therefore, an aspect of the invention provides a switchgear by which the aforementioned drawbacks can be avoided and which has a simple design and is simple to produce, and which preferably allows an element like a latching slide to be retrofitted.

As a result, it is possible to create a switchgear that has a simple design and in particular comprises a fastening device that is simple to produce. As a result, the complexity of the production of the switchgear can be reduced. According to a particularly preferred embodiment, the spring can be retrofitted. Therefore, the spring can be attached at a later point to an otherwise complete switchgear having a sealed housing.

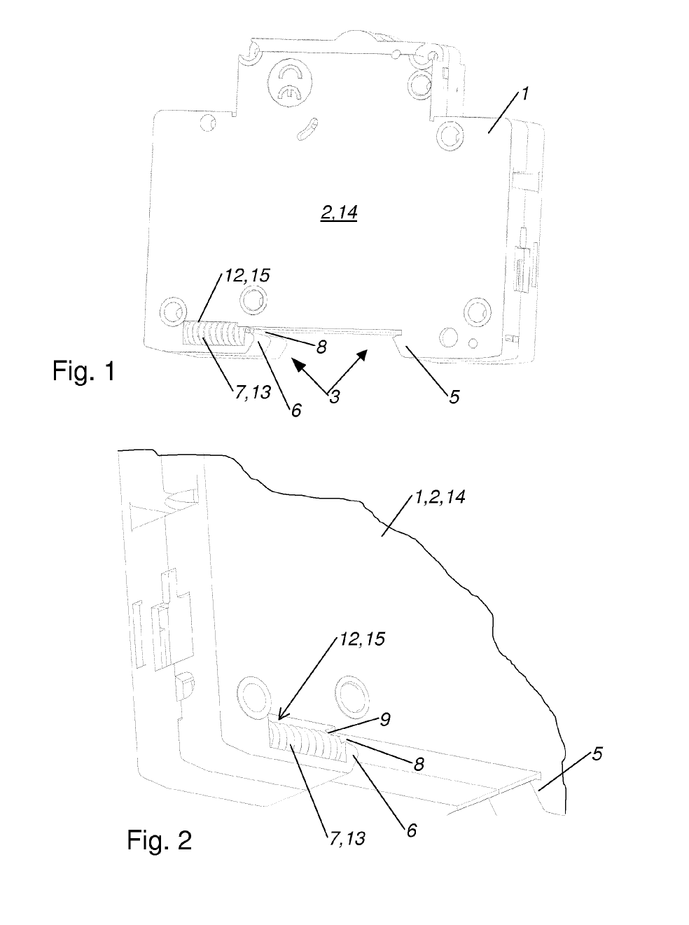

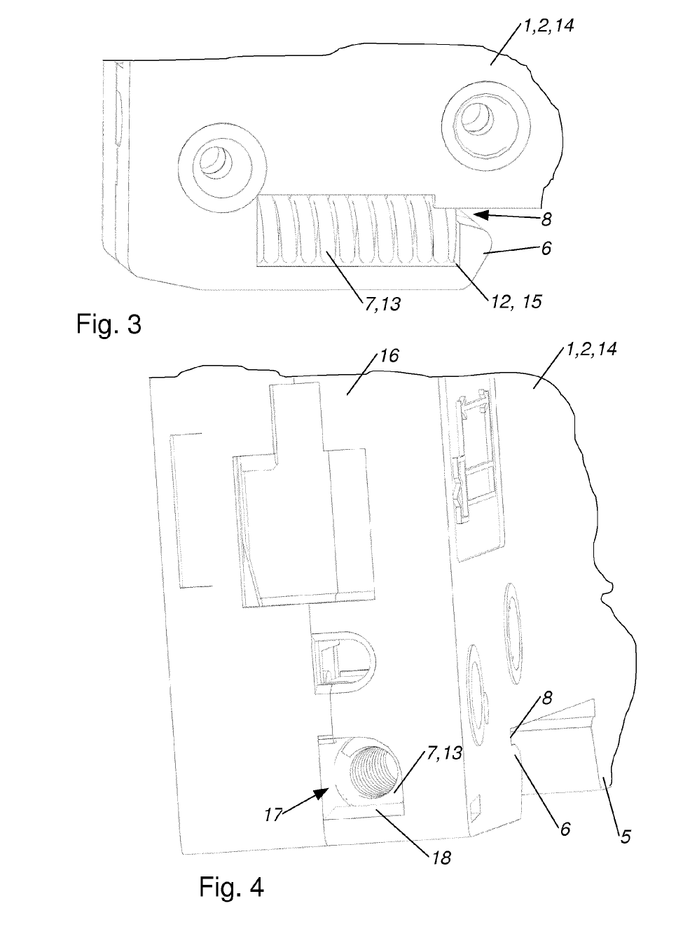

FIGS. 1 to 10 show different embodiments of a switchgear 1, a fastening device 3 for attaching the switchgear 1 to a DIN rail 4 being arranged on a housing 2 of the switchgear 1, the fastening device 3 comprising a stationary first fastening lug 5 and a second fastening lug 6 arranged opposite the first fastening lug 5, wherein the second fastening lug 6 is stationary, a spring 7 is arranged in the region of the second fastening lug 6 in a manner preloaded towards the first fastening lug 5, and some regions of the spring 7 protrude into a groove 8 defined by the second fastening lug 6.

As a result, it is possible to produce a switchgear 1 that has a simple design and in particular comprises a fastening device 3 that is simple to produce. The complexity of the production of the switchgear 2 can thus be reduced. According to particularly preferred embodiments, the spring 7 can be retrofitted. Therefore, the spring 7 can be attached at a later point to an otherwise completely assembled switchgear 1 having a sealed housing 2.

A switchgear 1 according to the invention can be any form of switchgear 1, the switchgear 1 in particular being in the form of “installation switchgear”, and more particularly in the form of a miniature circuit breaker. Preferably, the switchgear 1 is in the form of a residual current circuit breaker or an automatic circuit breaker.

The switchgear 1 comprises a housing 2 which is made of an insulating material, and, apart from terminals and a manual operation element that is preferably provided, completely encloses an interior of the switchgear 1.

The switchgear 1 comprises a fastening device 3 for attaching the switchgear 1 to a DIN rail 4. A DIN rail 4 is preferably a top hat rail. An example of this is shown in cross section in FIG. 11. DIN rails 4 of this type are commonly designed for arranging switchgear 1 in a distribution cabinet or a distribution board.

The fastening device 3 is integrally moulded or formed on the housing 2 and comprises a stationary first fastening lug 5, which forms a recess or a first DIN rail receptacle, for arranging a first leg of the DIN rail 4. The first fastening lug 5 preferably does not comprise any movable parts, and is merely formed as a rigid moulding on the housing 2. The first fastening lug 5 can also be formed in the same way as the second fastening lug 6, which will be described below, it also being possible to provide combinations of different preferred embodiments on the same switchgear 1.

A second fastening lug 6 is arranged on the housing 2 opposite the first fastening lug 5. The second fastening lug 6 is also stationary and is preferably formed or integrally moulded on the housing 2 as an integral part thereof. The second fastening lug 6 forms a groove 8 and a second DIN rail receptacle for arranging a second leg of the DIN rail 4.

A spring 7 is arranged in the region of the second fastening lug 6. The spring 7 is arranged in a spring receptacle 9, which in turn is preferably substantially arranged in the housing protrusion that forms the second fastening lug 6. In the process, regions of the spring 7 protrude into the groove 8 defined by the second fastening lug 6. The spring 7 is arranged in a preloaded state in the region of the second fastening lug 6, for which reason the part of the spring 7 protruding into the groove 8 pushes against a stop provided in this region. The spring 7 is preloaded in the direction of the first fastening lug 5 or towards the first fastening lug 5.

According to the first three preferred embodiments according to FIGS. 1 to 8, the spring 7 and the spring receptacle 9 and/or a spring insertion opening 12 are formed such that the spring 7 can be placed in the spring receptacle 9 when the housing 2 is closed. This makes it possible to form an assembly of a plurality of pieces of fully completed and checked switchgear 1, and to then retrofit the spring 7 at the now preferred location and to thus form a complete fastening device 3 on just one of the pieces of switchgear 1.

According to the first and second preferred embodiments of a switchgear 1 according to the invention, the spring 7 is in the form of a helical spring 13. This is an embodiment that is particularly simple to implement since helical springs 13 are widely available and do not have to be made as a separate component. Since the springs are widely available, if one spring breaks, these embodiments can also be repaired in a simple manner in remote locations.

FIGS. 1 to 3 show a first preferred embodiment of a switchgear 1 according to the invention, a first spring insertion opening 15, which provides access to the spring receptacle 9 arranged therebehind, being arranged in a first side face 14 of the housing 2. This allows the spring 7 to be inserted into the otherwise already completely assembled switchgear at a later point. In the process, the helical spring 13 is inserted into the first spring insertion opening 15 transversely to its longitudinal axis. The longitudinal extension of the first spring insertion opening 15 is shorter than the longitudinal extension of the spring receptacle 9 in order to prevent the helical spring 13 from drifting sideways. To insert the helical spring 13 into the spring insertion opening 15, said spring is compressed in some regions.

In this connection, a limiting rib is arranged in the region of the spring receptacle 9 and prevents the helical spring 13 from falling out of the switchgear 1 once it has been put in position. The delimiting rib can be a rib that extends in the longitudinal extension of the helical spring 13 and is arranged on the side thereof. Some regions of the helical spring 13 can also be arranged on a receiving pin that is integrally moulded on the housing 2 and is designed and arranged for the helical spring 13 to be placed thereon.

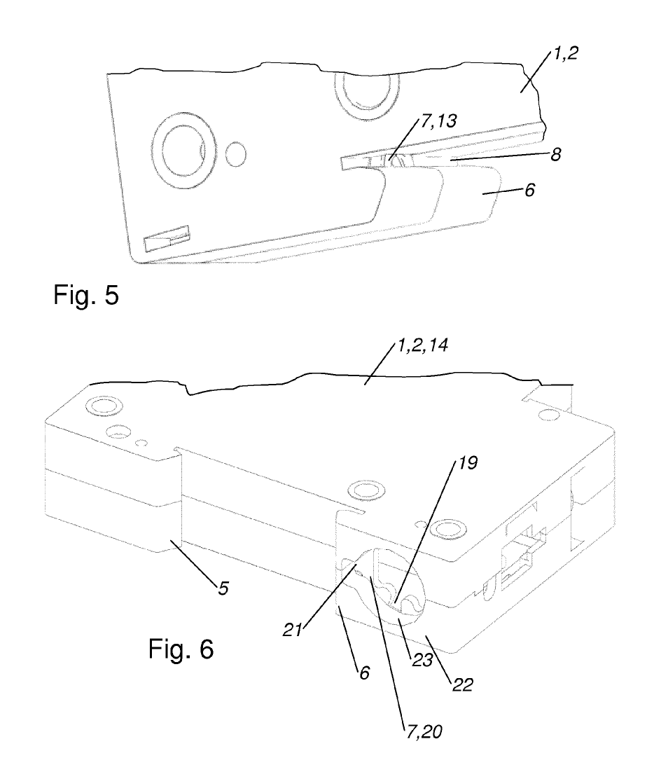

FIGS. 4 and 5 show a second preferred embodiment of a switchgear 1 according to the invention, a second spring insertion opening 17 being arranged in a first cover surface 16 of the housing 2 for inserting the helical spring 13 in the direction of its longitudinal axis. In this case, a cover surface 16 is designated as any of the surfaces on which one of the terminals of the switchgear 1 in question is arranged and which forms an underside in a conventional distribution cabinet, according to the preferred installation position of the switchgear 1 in question.

For insertion into the second spring insertion opening 17, the helical spring 13 is inserted therein along its longitudinal extension. In order to hold or fix the helical spring 13 in position in the second spring insertion opening 17, said opening can be closed by a cover, and the required preloading of the helical spring 13 can be generated and the spring can be secured in this way. Preferably, and as shown in FIG. 4, a latching protrusion 18 is arranged in the second spring insertion opening 17, as a result of which, in order to fit the helical spring 13, it merely has to be inserted into the second spring insertion opening 17 beyond a particular point of the latching protrusion 18, and so said fitting can take place in just one operation, and of course even after the switchgear 1 in question has been completely assembled.

FIGS. 6 to 8 show a third preferred embodiment of a switchgear 1 according to the invention, the spring 7 being substantially planar and comprising an annular basic shape 20 that is broken by a gap 19 and on which a contact projection 21 is integrally formed. The planar basic shape 20 is advantageous in that the housing moulding that forms the second fastening lug 6 can also be planar.

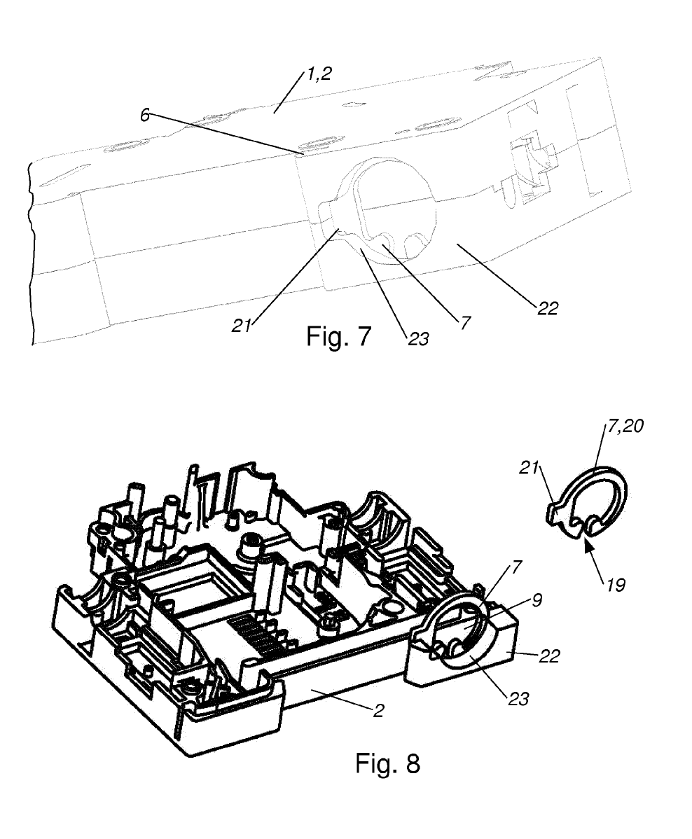

The planar spring 7 in question has a basic shape 20 that is similar to a circlip and allows the spring 7 to be retrofitted. FIG. 8 shows a detail of a corresponding spring 7.

A third spring insertion opening 23 for the substantially planar spring 7 is arranged in an underside 22 or rear side of the housing 2. A hole, through which the contact projection 21 on the planar spring 7 is guided, extends from the third spring insertion opening 23 into the groove 8.

The springs 7 of the aforementioned first, second and third preferred embodiments are preferably formed as metal springs.

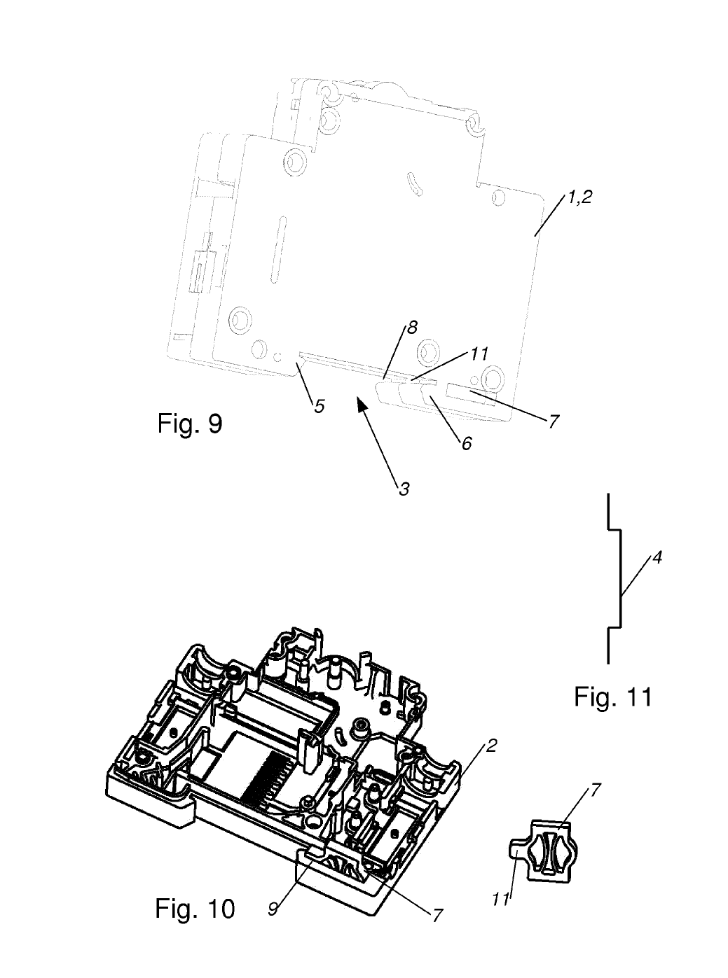

FIGS. 9 and 10 show a fourth preferred embodiment of a switchgear 1 according to the invention, the spring 7 being substantially planar and arranged inside the housing 2, apart from an actuation projection 11 protruding into the groove 8 through an actuation opening 10 in the housing 2. The spring 7 thus formed is shown in a detailed view in FIG. 10. Just like the planar spring 7 of the third preferred embodiment described above, this embodiment also has the advantage of a small installation depth.

The spring 7 in question of the fourth preferred embodiment is preferably formed as a plastics part, in particular as an injection-moulded plastics part, as a result of which the complexity of production and costs can be reduced.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A switchgear, comprising:
a fastening device configured to attach the switchgear to a DIN rail, the fastening device being arranged on a housing of the switchgear,
wherein the fastening device includes a stationary first fastening lug and a stationary second fastening lug arranged opposite the first fastening lug,
wherein a spring is arranged in the region of the second fastening lug in a manner preloaded towards the first fastening lug, and
wherein some regions of the spring protrude into a groove defined by the second fastening lug.

2. The switchgear of claim 1, wherein the spring is arranged in a spring receptacle.

3. The switchgear of claim 1, wherein the spring is substantially planar and is arranged inside the housing, apart from an actuation projection protruding into the groove through an actuation opening in the housing.

4. The switchgear of claim 2, wherein the spring and the spring receptacle and/or a spring insertion opening are formed such that the spring can be placed in the spring receptacle when the housing is closed.

5. The switchgear of claim 1, wherein the spring is a helical spring.

6. The switchgear of claim 5, wherein a first spring insertion opening is arranged in a first side face of the housing for inserting the helical spring transversely to its longitudinal axis, and
wherein a longitudinal extension of the first spring insertion opening is shorter than the longitudinal extension of the spring receptacle.

7. The switchgear of claim 5, wherein a second spring insertion opening is arranged in a first cover surface of the housing for inserting the helical spring in the direction of its longitudinal axis.

8. The switchgear of claim 7, wherein a latching protrusion is arranged in the second spring insertion opening.

9. The switchgear of claim 1, wherein the spring
is substantially planar,
has an annular basic shape that is broken by a gap, and on which a contact projection is integrally formed.

10. The switchgear of claim 9, wherein a third spring insertion opening for the substantially planar spring is arranged in an underside of the housing.
